(19) United States
(12) Patent Application Publication
(10) Pub. No.: US 2007/0279284 A1
(43) Pub. Date: Dec. 6, 2007

(54) Method To Design Polarization Arrangements For Mimo Antennas Using State Of Polarization As Parameter

(76) Inventor: Manoj Karayil Thekkoott Narayanan, Trichur District (IN)

Correspondence Address: ALIX YALE & RISTAS LLP, 750 MAIN STREET, SUITE 1400, HARTFORD, CT, 06103, US

(21) Appl. No.: 11/578,158

(22) PCT Filed: Apr. 8, 2004
(86) PCT No.: PCT/IN04/00096

§ 371 Date: Jun. 23, 2007

(51) Int. Cl. H04B 7/10

(52) U.S. Cl. 342/361

(57) ABSTRACT

The invention described herein provides a method of polarization based optimum constellation arrangements for modulation, multiplexing, diversity and spatio-temporal coding in wireless communication. The invention makes use of the polarization signal space to design optimal constellation arrangements, and to provide optimal State of Polarizations (SOPs) for Multiple-Input-Multiple-Output (MIMO) antennae for efficient diversity operations and for frequency re-use systems for multiplexing gains.

### FIELD OF THE INVENTION

Present invention relates to wireless communication and more specifically to wireless modulation, multiplexing and diversity schemes.

### BACKGROUND OF THE INVENTION

1. Description of the Prior Art

It is an accepted fact that polarization of an electromagnetic signal is an underutilized parameter in wireless communication for modulation and multiplexing, compared to, the other parameters such as amplitude, frequency and phase. Even though polarization has been used conventionally as a diversity parameter, its usage has been limited to the two orthogonal polarizations; mainly the linear horizontal polarization (LHP) & linear vertical polarization (LVP) pair or right handed circular polarization (RHCP) & left handed circular polarization (LHCP) pair. Same orthogonal polarization pairs have been used for multiplexing for the dual polarization frequency reuse systems for doubling the capacity of the wireless link. An efficient cross polarization interference canceller (XPIC) is one of the requirements for such operations. Even though polarization has been proposed and used as a modulating parameter in optical communication, it is seldom used in a wireless communication link. This significantly unused polarization spectrum is the resource that is being maximally and optimally utilized in this present invention.

### DISCLOSURE OF THE INVENTION

2. Summary of the Invention

The invention presented here relates to the use of State of Polarization (SOP) of an electromagnetic signal which can be used efficiently for modulation, multiplexing and diversity schemes as stand alone parameters or in conjunction with the other amplitude, phase, and frequency parameters of an electromagnetic wave. The SOPs mentioned in this invention are different from the normally used LVP, LHP, RHCP, and LHCP. By using the unused polarizations of the polarization domain, the invention makes use of the polarization signal space to design optimal constellation arrangements, and to provide optimal SOPs for Multiple-Input-Multiple-Output (MIMO) antennae for efficient diversity operations and for frequency re-use systems for multiplexing gains more than 2.

It is an object of the present invention to provide a set of polarization constellation diagrams, for modulation, diversity or multiplexing operations. Various arrangements different from prior art are given for 3 point, 4 point, 6 point and 8 point constellations. These constellations are marked on the Poincarésphere and each of these constellations have optimum and/or sub optimum properties as regards to the cross polarization isolation (XPI), Euclidean distance and bit error rate (BER).

When used in modulation such as M-array Polarization Shift Keying (MPolSK), these constellations act as the signal set for symbol mapping. When used in diversity/multiplexing operations of MIMO systems, these constellation points represent the SOP of the transmitting/receiving antennae.

It is a further object of the present invention to provide the systems and circuits to generate these individual State of Polarizations (SOPs) and the constellation arrangements for wireless communication. Three different ways of generating these polarizations or their constellations have been provided in this invention. In the first approach, combinations of two orthogonal polarizations (linear or circular) antennae are used together with a signal processor at the base-band to generate these polarizations. This approach is meant for MPolSK systems which introduce required SOPs for a sinusoidal signal. The second approach is also for a sinusoidal signal, where the signal processor at the base-band is replaced by phase shifters and attenuators at the RF. These components introduce the required phase shift and amplitude to the orthogonal polarizations to generate the required SOP. In the third approach, a means is described for polarizing a carrier modulated signal at RF. This approach is useful in MIMO systems.

It is further object of the invention to provide an advantageously simple Quaternary Polarization shift keying system (QPolSK) which uses polarization as the modulating parameter. In this object of the invention, the demodulator and an optimum receiver design in the Stokes space are provided.

It is a further object of the present invention to provide a co-channel multi- polarization frequency reuse system employing more than 2 polarizations for enhanced spectrum efficiency and for providing higher data rate for a communication link. In the prior art, frequency re-use systems employing 2 orthogonal polarization is the presented where as this embodiment of the invention presents techniques for using more than 2 polarizations for multiplexing (re-use) operation. This object of the invention uses an optimally designed set of 3 or 4 polarizations together with suitable cross polarization interference cancellers and offer 3 or 4 channels for multiplexing.

It is a further object of the invention to provide a mechanism to design orthogonal or substantially orthogonal polarizations for MIMO systems to enhance their performance. The antenna with the suggested polarizations will be resulting in channels with uncorrelated fading which is a requirement for efficient reception at the receiver for MIMO systems. By this object of the invention, the spatial separation requirement in the order of the many wavelengths required otherwise in the prior art can be eliminated. This allows the antennas to be closely located, more antennae to be deployed and also facilitates antenna array with multiple beams with each beam of separate polarization to be used in MIMO systems. By this arrangement another degradation caused by varying angle of arrival also can be eliminated.

Still other objects and advantages of the present invention will become readily apparent to those skilled in this art from the detailed description, wherein only a preferred embodiment of the invention are shown and described, simply by way of illustration of the best mode contemplated to carry out the invention. As will be realized, the invention is capable of other and different embodiments, and its several details are capable of modifications in various obvious respects, all without departing from the invention.

### BRIEF DESCRIPTION OF THE DRAWINGS signal.

FIG. 1. Poincarésphere representation of State of Polarization (SOP) of an electromagnetic

FIG. 2. Poincarérepresentation angle pairs (2γ,δ) or (2ε,2τ)

FIG. 3. Stokes space parameters for representation of SOP

FIG. 4. Using orthogonal polarizations to generate any SOP; selection of the amplitudes and phases at base-band.

FIG. 5 Variable amplitude and phase using a phase shifter and attenuator at RF.

FIG. 6. Carrier modulated signals and SOP selection

FIG. 7. Smart antenna for generating any pre-selected SOP

FIG. 8 Smart antennas at the receiver

FIG. 9. Antenna geometry of a square patch with one side as LHP and the other side as LVP.

FIG. 10. Variation, of S11 with frequency

FIG. 11. Radiation Pattern

FIG. 12. Physical parameters of the antennar

FIG. 13. 3 point constellation with 3 linear polarizations

FIG. 14. 3 point constellation with 2 linear polarizations and 1 Circular polarization

FIG. 15. 3 Linearly polarized dipoles to generate the constellation diagram of FIG. 13

FIG. 16. 4 point constellation with 2 RHEP polarizations and 2LHEP polarizations.

FIG. 17. The BER performance for the constellation diagram given in 17.

FIG. 18. 4 point constellation with 3 elliptical polarizations and 1CP

FIG. 19. 4 point constellation with 2linear polarizations and 2CP

FIG. 20. 4 point constellation with 4 linear polarizations

FIG. 21. A simple quadrature polarization shift keying system for wireless

FIG. 22. 6 point constellation with 4 linear polarizations and 2CP

FIG. 23. 8 point constellation with 4 RHEP and 4LHEP

FIG. 24. BER performance of the 8 point constellation compared to that of 8PSK

FIG. 25. Frequency re-use with 3 polarizations

FIG. 26. Frequency re-use with 4 polarizations

FIG. 27. Transmitter Antenna arrangement for a 3 in 3 out MIMO system (SOPs as in FIG. 14)

FIG. 28. Transmitter Antenna arrangement for a 3 in 3 out MIMO system (SOPs as in FIG. 13)

### DESCRIPTION OF PREFERRED EMBODIMENT

To those skilled in the art, the invention admits of many variations. The following is a description of a preferred embodiment offered as illustrative of the invention but not restrictive of the scope of the invention.

Polarization of an Electromagnetic signal describes the movement of the electric field vector at one point in space as the wave progresses through that point. The tip of the electric field vector can trace a line resulting in linear polarization, a circle resulting in circular polarization or more generally an ellipse, resulting in elliptical polarization. Polarization ellipse is the general representation and the linear and circular polarizations are special cases of elliptical polarizations.

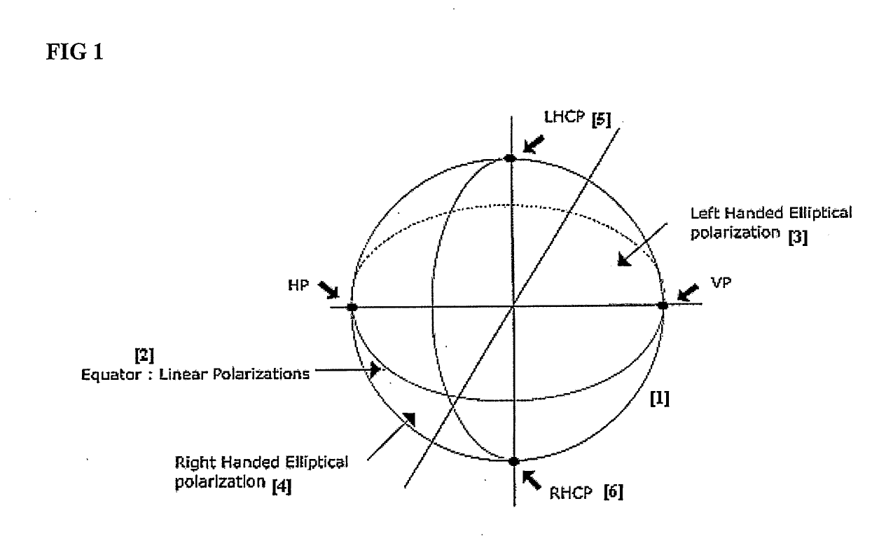

FIGS. 1, 2 and 3 describe the general state of art relating to the polarization of an electromagnetic signal, representations of a signal or antenna including Poincarésphere and the Stokes space.

FIG. 1 shows a Poincarésphere [1] which can be used to represent the SOPs on graphical representation. The linear polarizations are on the equator [2], the left handed polarizations [3] on the upper hemisphere, and right handed polarizations [4] on the lower hemisphere. The North Pole represents the LHCP [5] and South Pole represents the RHCP [6].

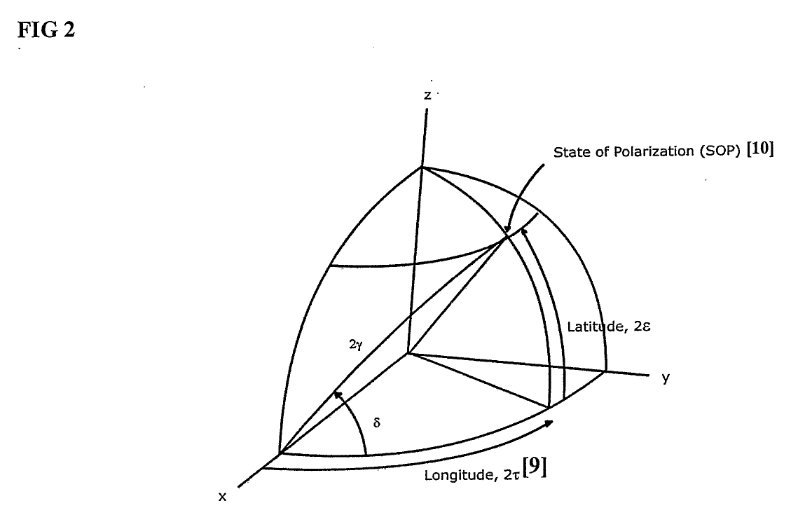

The points on the sphere are located using two pairs of angle which are related to each other, as shown in FIG. 2. The pair of angle used are
1. (γ,δ) pair where 2γ is the great circle distance from the LHP [7] point and δ is the angle of the great circle with respect to the equator [2].
2. (2τ,2ε) pair where 2τ is the longitude [9]and 2ε is the latitude [10].

Any SOP can be represented mathematically as the combination of two orthogonal linear polarizations \vec{E}ₓ and \vec{E}ₓ.
\vec{E}ₓ=a₁cos(τ+δ₁) (A)
\vec{E}_{y}=a₂cos(τ+δ₂) (B)
where a₁ and a₂ are their respective amplitudes and
δ=δ₂−δ₁ (c)
is the phase difference between the y component of the electric field with respect to the x component. The angle γ is given by

$$γ = {tan}^{- 1} ( \frac{{a}_{2}}{{a}_{1}} ) \qquad ( D )$$

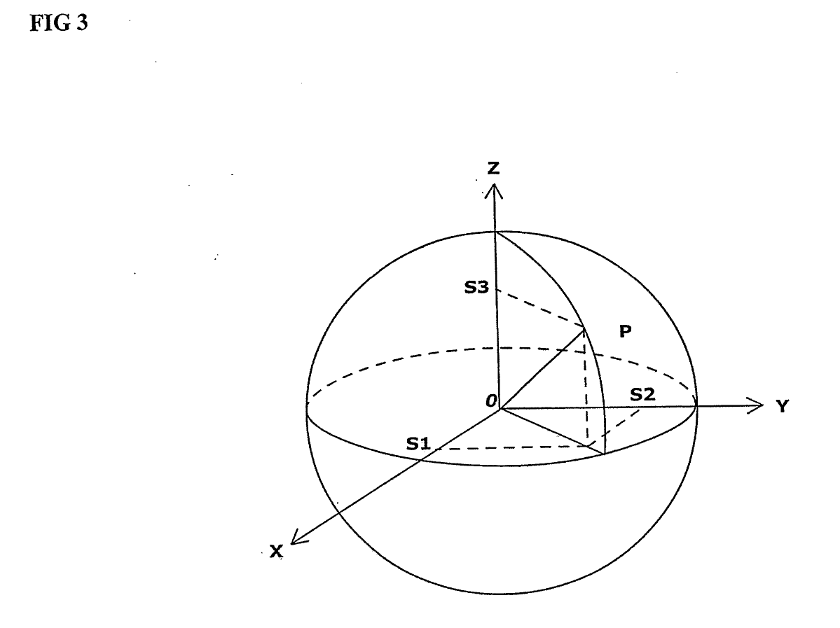

FIG. 3 shows another useful representation of SOP known in literature as Stokes parameters representation. Following the description in (B), for a signal with the {Ex, Ey, Ez} defined by

$$\begin{matrix}{E}_{x} = {a}_{1} cos ( τ + {δ}_{1} ) , \\ {E}_{y} = {a}_{2} cos ( τ + {δ}_{2} ) , \\ {E}_{z} = 0\end{matrix} \} \qquad ( E )$$

the Stokes parameters are given by

$$\begin{matrix}{s}_{0} = {a}_{1}^{2} + {a}_{2}^{2} , \\ {s}_{1} = {a}_{1}^{2} - {a}_{2}^{2} , \\ {s}_{2} = 2 {a}_{1} {a}_{2} cos δ , \\ {s}_{3} = 2 {a}_{1 } {a}_{2} sin δ\end{matrix} \} \qquad ( F )$$

Any elliptically polarized SOP can be generated by using 2 linearly polarized components (LHP [7] & LVP [8]) of appropriate amplitudes and relative phases. Another method for representing and generating these SOPs are by using two RHCP [6] and LHCP [5] components of appropriate amplitudes and phase shift. If the media involves ionosphere, linear components may be affected by Faraday rotation, whereas circularly polarized components are immune to the rotation. A method to decompose any SOP into (LVP [8] and LHP [7]) or (RHCP [6] and LHCP [5]) is illustrated in (C). All the methods of implementation involve an array of two elements which generate the LHP [7], LVP [8] signals of appropriate amplitude and phases or alternatively LHCP [5], RHCP [6] signals. If the orthogonal polarizations are selected as the LHP [7], LVP [8] combination, the antenna structure will henceforth be called as Orthogonal Linear Combination Array (OLCA) [11]. If the orthogonal polarizations are the LHCP [5], RHCP [6] combination, the antenna structure will henceforth be called as Orthogonal Circular Combination Array (OCCA) [12]. An OLCA [11] or an OCCA [12] is a 2 element antenna array which can generate any SOP based on the amplitude and phase of the signal at its input ports. Such an antenna is described in detail in further below.

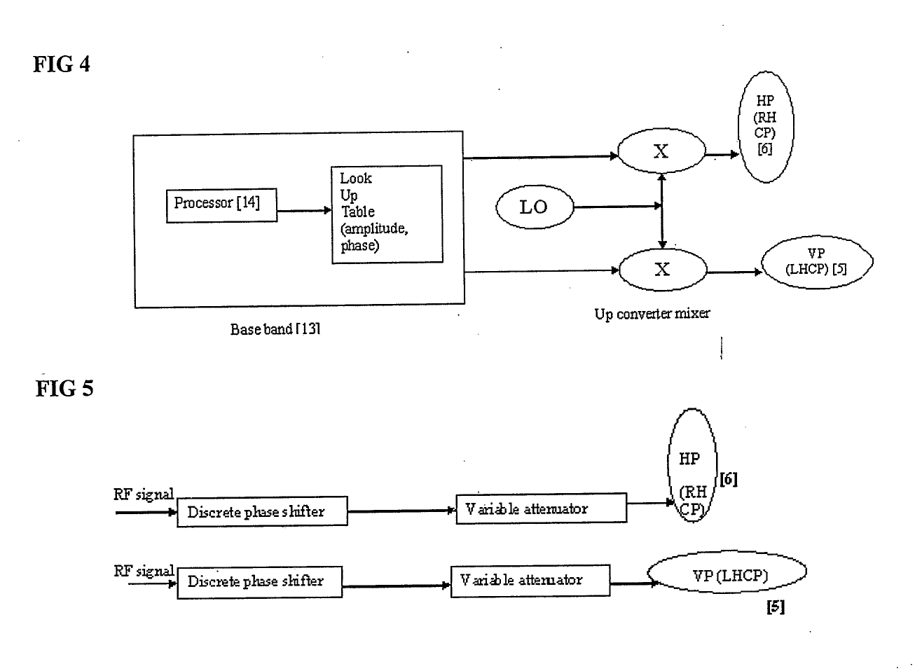

Various forms of realization of the required SOPs are shown in the FIGS. 4, 5, 6, and 7. In FIG. 4, the required SOP is generated by an OLCA [11] or an OCCA [12] with the selection of the suitable amplitude and phase from a look up table which is performed at the base-band [13]. This implementation is meant for a sinusoidal signal which is usually the case with a Polarization shift keying systems. The processor [14] in the base band will be reading the amplitude and phase values for both the channels and the sinusoidal signals of these amplitudes and phases will be generated by using a direct wireless synthesizer or any other suitable means, and later, up converted to the higher RF range by the up converter mixer.

In FIG. 5, another implementation for a sinusoidal signal is shown. Here the amplitude and phase shifts are performed in RF and are suitable for Polarization shift keying systems which do not employ a processor [14] at the base-band [13]. The phase shifting and amplitude selection can be controlled electronically by using suitable continuous time or discrete time circuits.

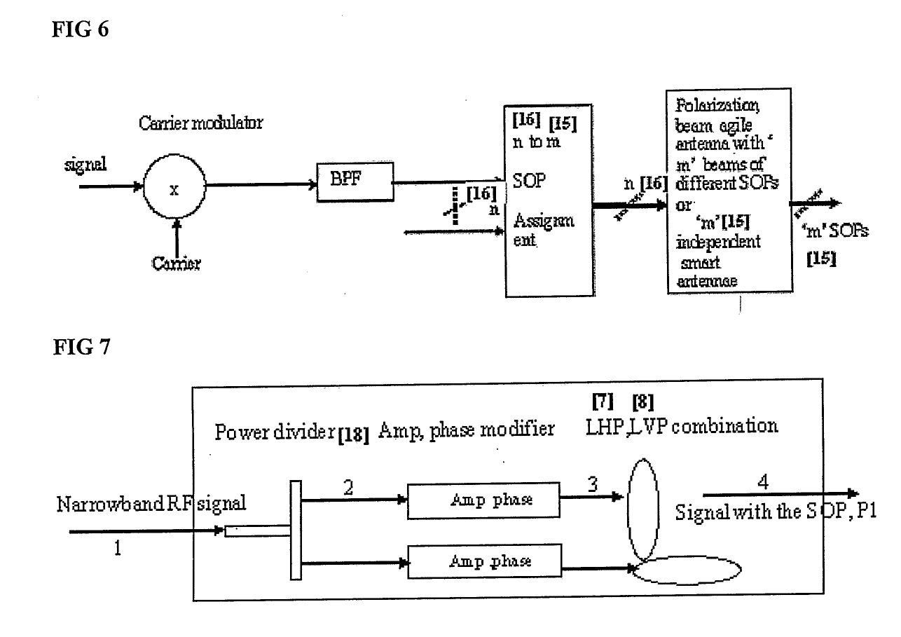

In FIG. 6, the signal to be polarized is a carrier modulated signal. In this case, if ‘m’ [15] State of Polarizations are needed, the radiating mechanism should be a polarization agile antenna generating ‘m’ [15] beams with each having different polarization sense or a collection of ‘m’ [15] smart antenna elements each with different SOPs. An intelligent ‘n’ [16] to ‘m’ [15] mapping circuit will map the carrier modulated narrow band signals to their respective SOPs based on some predefined criteria. Such an arrangement is suitable for the frequency reuse systems, MIMO systems and polarization diversity schemes.

A polarization agile smart antenna which can polarize a narrow band signal to any pre-selected SOP is shown in FIG. 7. It consists of a power divider [8], which splits the power equally into 2 in-phase branches. The amplitudes and phases of these branches are then modified (using predetermined scaling and shifting values) which are determined by the required SOP. These scaled and shifted signals are then fed to the two ports of a OLCA [11] or an OCCA [12] which in the far field will generate the required SOP.

These modifications are later corrected at the receiver side to regenerate the original carrier modulated signal.

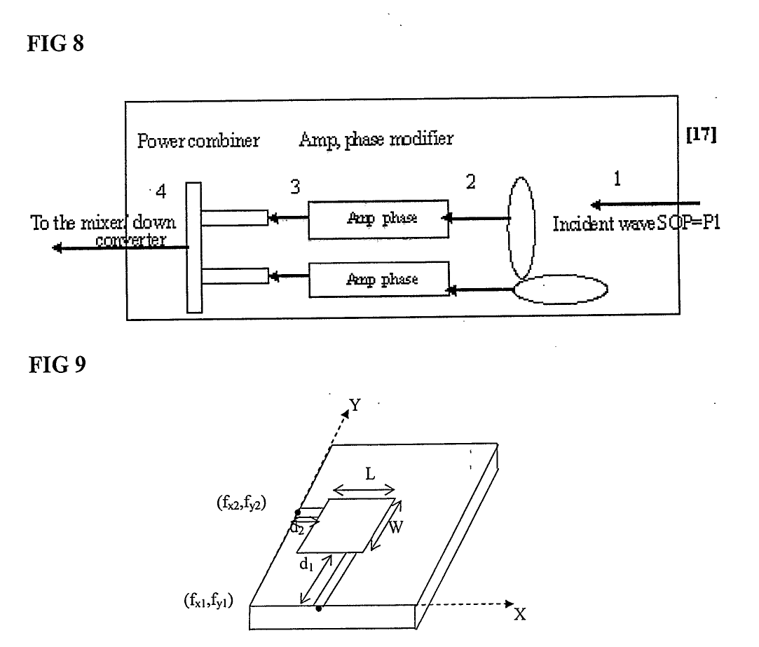

Such a smart antenna [17] at the receiver side is shown in FIG. 8. Here, the amplitudes and phases of the received signals are corrected by using the same proportion to cancel the changes introduced at the transmitter. The received RF signal is usually then fed to the mixer/down converter for the receiver signal processing. The single element planar antenna which performs as an OLCA [11] is described in this embodiment of the invention. This antenna is called as Dual port Micro strip line fed square patch antenna.

FIG. 9 shows the structure of the dual port square patch antenna for the frequency range 2.4 GHz. The resonating frequency and operating bandwidth are:

TABLE 1
Resonating frequency and operating band of the
LHP [7] feed and LVP [8] feed

| Port | Resonating Frequency GHz | Operating Band | % Bandwidth |
|---|---|---|---|
| Port 1 | 2.455 | 2.515-2.395 | 4.9 |
| Port 2 | 2.4075 | 2.36-2.455 | 3.9 |

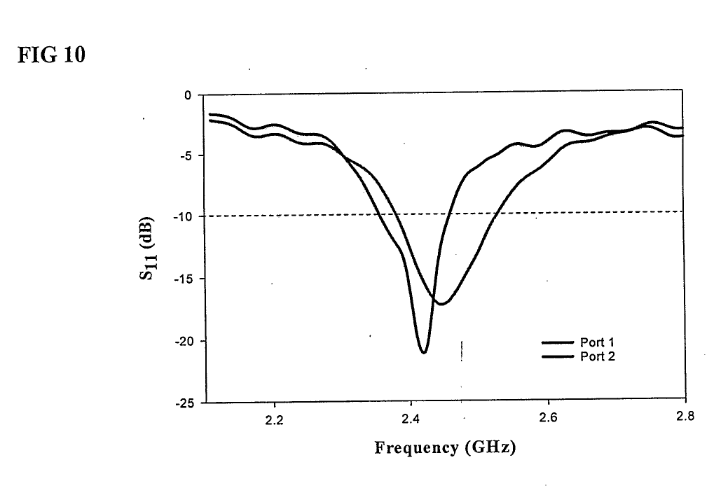

FIG. 10 shows the variation of S11 for both the ports. It can be seen that the antenna offers a good bandwidth at these frequencies.

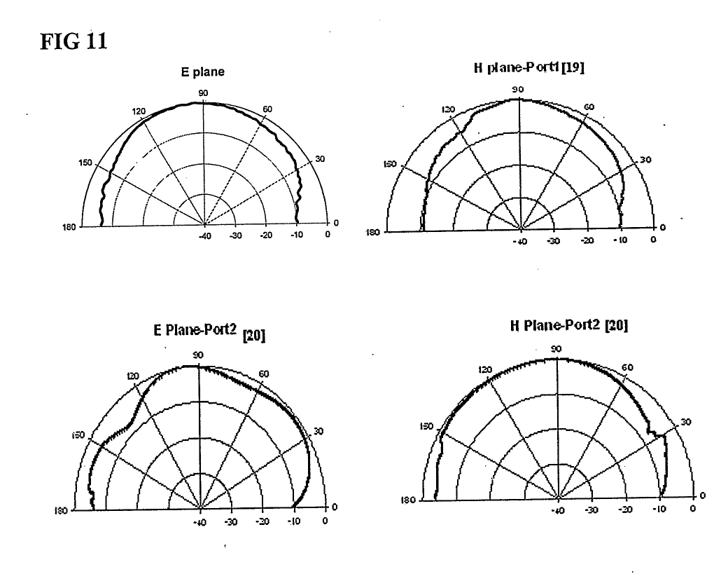

FIG. 11 shows the radiation pattern of the antenna with the ports of excitation being port 1 [19] and port 2 [20] separately.

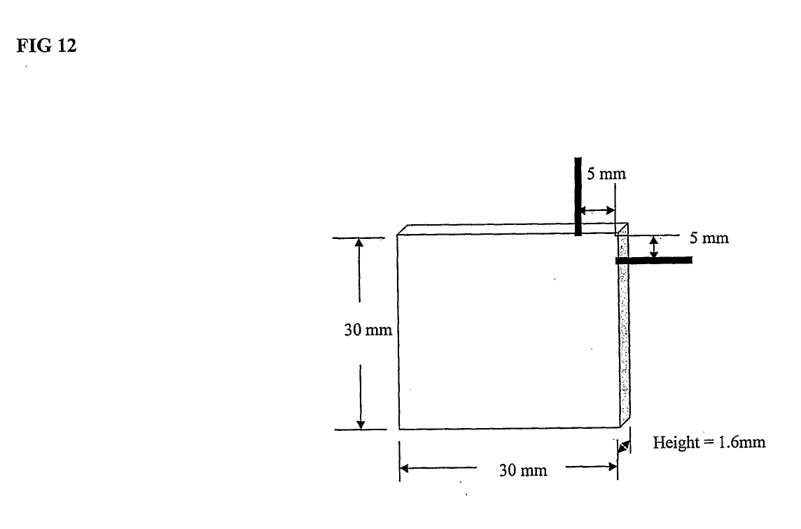

The physical parameters of the antenna are shown in FIG. 12.
Dimension L×W=30×30 mm²
Substrate dielectric constant εr=4.28
Thickness h=1.6 mm.

The antenna is found to resonate at 2.455 GHz at port 1 and at 2.4075 GHz at port 2 [20].

In this part of the invention, novel constellation arrangements in polarization signal space intended for wireless communication applications are presented. These constellation arrangements and the constituent SOPs are different from the polarizations used in wireless communication in the prior art. In the prior art, the polarization used for signal or antennae are mainly the LHP [7], LVP [8], +45 linear, RHCP [6], and LHCP [5]. Occasionally elliptical polarization is used but, the position of the SOP of such elliptical polarization on a Poincarésphere was inconsequential for such applications. In this part of the invention, every constellation diagram is followed by the constituent LHP [7], LVP [8] amplitude and phases required for its generation using an OLCA [11].

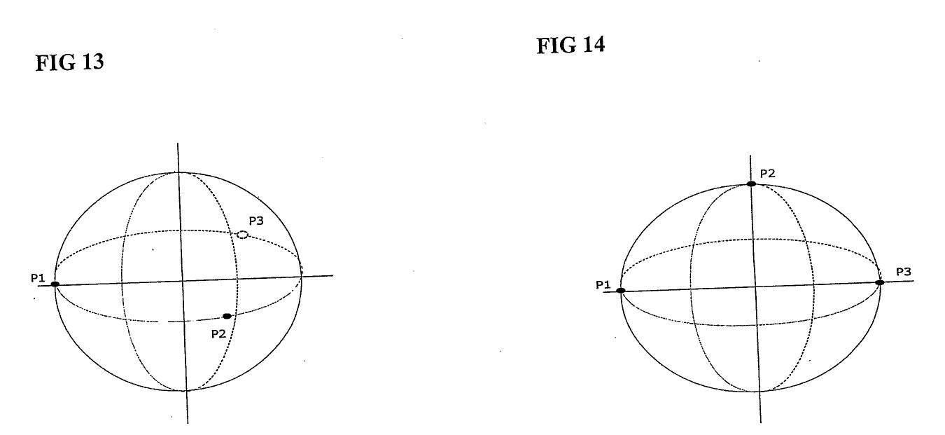

The constellation arrangements employing three points in the polarization signal space which provide advantageous benefits to a wireless communication system are shown in FIG. 13 and FIG. 14.

The constellation arrangement in FIG. 13 shows three points in the polarization signal space with maximum Euclidean distance of 1. 73 on a unit sphere. These SOPs provide maximum isolation among themselves and when used in Polarization shift keying schemes, they provide maximum BER performance due to the maximum Euclidean distance. Poincarérepresentation angle pairs (2γ,δ) or (2ε,2τ) for the 3 points of constellation in FIG. 13 are given below:

TABLE 2

| Points | | | | | | | | | | |
|---|---|---|---|---|---|---|---|---|---|---|
| (all angles | | | | | | | | | | |
| in degrees) | 2ε | 2τ | 2γ | δ | S₁ | S₂ | S₃ | α₁ | α₂ | δ |
| P₁ | 0 | 0 | 0 | 0 | 1 | 0 | 0 | 1 | 0 | 0 |
| P₂ | 0 | 120 | 120 | 0 | −0.5 | 0.866 | 0 | −0.5 | 0.866 | 0 |
| P₃ | 0 | 240 | 240 | 0 | −0.5 | −0.866 | 0 | −0.5 | −0.866 | 0 |

The Stoke's parameters of these SOPs are given in the same table. The amplitudes of the LHP [7] component, a₁ and LVP [8] component a₂ and the relative phase difference between them δ=δ₂−δ₁ are also provided in the table. The value of δ is the angle by which the γ component leads the x component. The 3 points P1, P2, P3 can be represented mathematically as;
P1:
   \vec{E}ₓ(t)=1.(\vec{x} cos ωt))
   \vec{E}_{y}(t)=0 (G1)
P2:
   \vec{E}ₓ(t)=−0.5(\vec{x} cos(ωt))
   \vec{E}_{y}(t)=0.866(\vec{x} cos(ωt)) (G2)
P3:
   \vec{E}ₓ(t)=−0.5(\vec{x} cos(ωt))
   \vec{E}_{y}(t)=−0.866(\vec{x} cos(ωt+90°)) (G3)

The 3 polarizations are linear polarizations and the antennae for such a combination can be designed easily. 3 dipoles, one in horizontal direction, one in +60° to the horizontal and another one 120° to the horizontal can generate these polarizations. Essential data for the 3 point constellation in FIG. 14 is given below:

TABLE 3

| Points | 2ε | 2τ | 2γ | δ | S₁ | S₂ | S₃ | α₁ | α₂ | δ |
|---|---|---|---|---|---|---|---|---|---|---|
| P₁ | 0 | 0 | 0 | 0 | 1 | 0 | 0 | 1 | 0 | 0 |
| P₂ | 90 | 90 | 90 | 90 | 0 | 0 | 1 | 0.707 | 0.707 | 90 |
| P₃ | 0 | 180 | 180 | 0 | −1 | 0 | 0 | 0 | 1 | 0 |

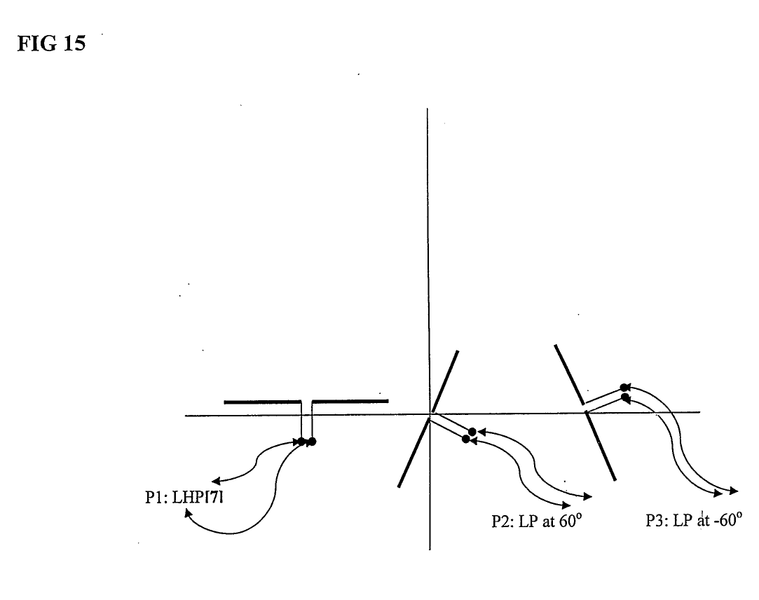

Such an arrangement is shown in FIG. 15. One another method to generate these SOPs is to use a LHP [7] antenna for P1, a LOCA for P2 and another LOCA for P3.

Another 3 point constellation on Poincarésphere is provided in FIG. 14. It uses two orthogonal linear polarizations and a left handed circular polarization (could as well be RHCP [6]). An advantage of this arrangement is the ease of generating these polarizations. The two linear polarizations are the commonly used LHP [7] and LVP [8] for which many antennae are available of the shelf for most of the frequencies. To generate the CP, another set of LHP [7] and LVHP [5] are required with a fixed attenuator and phase shifter as shown in FIG. 7 or any conventional circular polarized antenna can be used thus eliminating the need for new design and fabrication. However, the Euclidean distance is only 1.414 in this case compared to the 1.73 of the previous arrangement.
P1:
   \vec{E}ₓ(t)=1(\vec{x} cos(ωt))
   \vec{E}_{y}(t)=0 (H1)
P2:
   \vec{E}ₓ(t)=0.707(\vec{x} cos(ωt))
   \vec{E}_{y}(t)=0707(\vec{x} cos(ωt+90°)) (H2)
P3:
   \vec{E}ₓ(t)=0
   \vec{E}_{y}(t)=1(\vec{x} cos(ωt)) (H3)

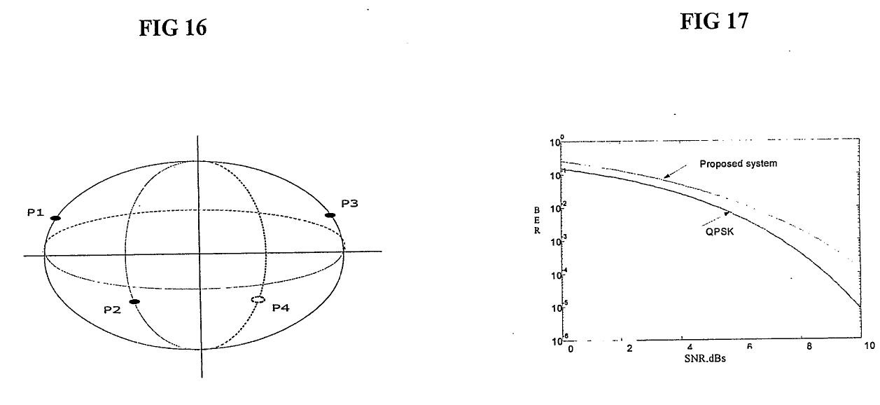

Two 4 point optimal constellation arrangements are shown in FIG. 16 and FIG. 17 both these arrangements provide a maximum Euclidean distance of 1.663 on a unit sphere. An analysis of the constellation set in FIG. 6 is performed here for determining its performance for an AWGN channel when used for M-PolSK modulation. Such modulations can be used where the depolarizing effect of the channel is minimum such as inter-satellite links.

Consider the symmetrically arranged 4 points on the Poincarésphere shown in FIG. 16. Points on the upper plane are called High Plane 1 (HP1) and High Plane 2 (HP2). Points on the lower hemisphere are called Low Plane 1 (LP1) and Low plane 2 (LP2) respectively. Their Poincarérepresentation parameters, stokes parameters and the orthogonal component amplitudes and phases are given below:

TABLE 4

| Points | 2ε | 2τ | 2γ | δ | S₁ | S₂ | S₃ | α₁ | α₂ | δ |
|---|---|---|---|---|---|---|---|---|---|---|
| P₁ | 35.26 | 0 | 35.26 | 90 | 0.8166 | 0 | 0.5773 | 0.9530 | 0.3028 | 90 |
| P₂ | −35.26 | 90 | 90 | −35.26 | 0 | 0.8166 | −0.5773 | 0.7071 | 0.7071 | −35.26 |
| P₃ | 35.26 | 180 | 144.7 | 90 | −0.8166 | 0 | 0.5773 | 0.3028 | 0.9530 | 90 |
| P₄ | −35.26 | 270 | 90 | −144.7 | 0 | −0.8166 | 0.5773 | 0.7071 | 0.7071 | −144.7 |

It should be noted that these four points are at maximum Euclidean distance (dₘᵢₙ) between each other given by
dₘᵢₙ=2\sqrt{2}/\sqrt{3}

These 4 points are elliptically polarized with HP1 and HP2 as left handed elliptically polarized, and LP1 and LP2 as right handed elliptically polarized. The electrical vectors of these 4 points are completely described by their amplitudes and relative phase differences which can be easily found from the Stokes parameters. The constituent electric vectors are given by the following equations for these four points at the z=0 plane.
P1:
   \vec{E}ₓ(t)=0.953(\vec{x} cos ωt)
   \vec{E}_{y}(t)=0.303{\vec{x} cos(ωt+90°)} (I1)
P2:
   \vec{E}ₓ(t)=0.707(\vec{x} cos ωt)
   \vec{E}_{y}(t)=0.707{\vec{x} cos(ωt−35.27°)} (I2)
P3:
   \vec{E}ₓ(t)=0.303(\vec{x} cos ωt)
   \vec{E}_{y}(t)=0.953{\vec{x} cos(ωt+90°)} (I3)
   and
P4:
   \vec{E}ₓ(t)=0.707(\vec{x} cos ωt)
   \vec{E}_{y}(t)=0.707{\vec{x} cos(ωt−144.7°)} (I4)

The elliptically polarized SOPs can be generated by using 2 linearly polarized components of appropriate amplitudes and relative phases. Another method for representing and generating these SOPs are by using two RHCP [6] and LHCP [7] components of appropriate amplitudes and phase shift. A method to decompose any SOP into RHCP [6] and LHCP [5] is straight forward [C] and following the standard method; the four points can be split as shown below.
HP1:
   \vec{E}_{L}(t)=0.6283(\vec{x} cos ωt−\vec{y} sin ωt)
   \vec{E}_{R}(t)=0.3248(\vec{x} cos ωt+\vec{y} sin ωt) (J1)
HP2:
   \vec{E}_{L}(t)=0.6283(\vec{x} cos ωt−\vec{y} sin ωt)
   \vec{E}_{R}(t)=0.3248{\vec{x} cos(ωt+π)+\vec{y} sin(ωt+π)}
   =−0.3248{\vec{x} cos(ωt)+\vec{y} sin(ωt)} (J2)
LP1:

$${{E}^{->}}_{L} ( t ) = 0.3248 ( {x}^{->} cos ω t - {y}^{->} sin ω t ) \\ \begin{matrix}{{E}^{->}}_{R} ( t ) = 0.6283 \{ {x}^{->} cos ( ω t + \frac{{π}^{∘}}{2} ) + {y}^{->} sin ( ω + \frac{{π}^{∘}}{2} ) \} \\ = 0.6283 \{ - {x}^{->} sin ( ω {t}^{∘} ) + {y}^{->} cos ( ω {t}^{∘} ) \}\end{matrix} \qquad ( J3 )$$

and LP2:

$${{E}^{->}}_{L} ( t ) = 0.3248 ( {x}^{->} cos ω t - {y}^{->} sin ω t ) \\ \begin{matrix}{{E}^{->}}_{R} ( t ) = 0.6283 \{ {x}^{->} cos ( ω t + 3 \frac{π}{2} ) + {y}^{->} sin ( ω t + 3 \frac{{π}^{∘}}{2} ) \} \\ = - 0.6283 \{ {x}^{->} cos ( ω t ) + {y}^{->} sin ( ω t ) \}\end{matrix} \qquad ( J4 )$$

It should be noted that for the points HP1 and HP2, the LHCP [5] vector is stronger than the RHCP [6], indicating left handed elliptical polarization. Similarly, for the points LP1 and LP2, the RHCP [6] components are stronger indicating a right handed elliptical polarization. Another important point to note here is that, all these points can be generated by a signal set of 3 vectors given by
u₁(t)=(\vec{x} cos ωt−\vec{y} sin ωt)
u₂(t)=(\vec{x} cos ωt+\vec{y} sin ωt)
u₃(t)=(−\vec{x} sin ωt°+\vec{y} cos ωt)° (K)

The vector u₃(t) is basically u₂(t) with a 90° phase shift. In the next section, these three vectors will be used as an orthogonal basis set to represent the four constellation points.

Orthogonal circular polarizations are used to generate the four points. It can be implemented by using two radiators which are RHGP [6] and LHCP [5] with proper amplitudes and phase difference. These amplitudes and phase difference are given below:

TABLE 5
Amplitude and phase for a OCCA [12] to
generate the constellation in FIG. 16

| Point | E_{R} | E_{L} | Phase (θ_{R}-θ_{L})° |
|---|---|---|---|
| HP1 | 0.6283 | 0.3248 | 0 |
| HP2 | 0.6283 | 0.3248 | 180 |
| LP1 | 0.3248 | 0.6283 | 90 |
| LP2 | 0.3248 | 0.6283 | 270 |

The receiver is based on a receiving antenna where the SOP of the antenna is determined by the relative amplitude and phase of the constituent circular polarizations. The implementation of this circuit can be performed based on a signal processor as the controller together with the radiating elements. The received SOPs are fed to a Stokes space receiver for optimum detection.

The signal space for the proposed constellation, arrangement can be represented by three orthogonal basis functions which can be identified from the constituent vectors used to represent the constellation points. They are given by equation (K). Orthogonality of these functions can be verified easily. Normalizing these basis functions yield their amplitude as
A=¹/\sqrt{T}ₛ
where T_{S} is the symbol time. The three ortho-normal signals can be used to represent each of the constellation points as
s(t)=a₁u₁(t)+a₂u₂(t)+a₃u₃(t) (L)

This space can be superimposed onto the Stokes space and proper selection of T_{S} can result in the set {a₁,a₂,a₃} to be same as the Stokes parameters given in Table 4. For the points on the unit sphere, with \sqrt{E}ₛ=1 and

$${d}_{min} = \frac{2 \sqrt{2}}{\sqrt{3}} ,$$

the set of coordinates of each point is given as below.

$$HP 1 \text{:} \{ {d}_{min} / 2 , 0 , {d}_{min} / 2 \sqrt{2} \} \\ HP 2 \text{:} \{ - {d}_{min} / 2 , 0 , {d}_{min} / 2 \sqrt{2} \} \\ LP 1 \text{:} \{ 0 , {d}_{min} / 2 , - {d}_{min} / 2 \sqrt{2} \} and \\ LP 2 \text{:} \{ 0 , - {d}_{min} / 2 , - {d}_{min} / 2 \sqrt{2} \} \qquad ( M )$$

Let n₁, n₂, n₃ be the relevant noise components along the three axes with zero mean and variance σ²=η/2. It will be convenient to calculate the probability of correct decision p_{c} and then determine the probability of symbol error as pₛ=1−p_{c}.

Assuming that the point HP2 is transmitted, the probability of a correct decision is given by

$$\begin{matrix}P ( C / {HP}_{2} ) = ( \frac{1}{\sqrt{( π η )}} {\int }_{- ∞}^{d / 2} {ⅇ}^{- {n}_{1}^{2} / η} ⅆ {n}_{1} ) ( \frac{1}{\sqrt{( π η )}} {\int }_{- d / 2}^{d / 2} {ⅇ}^{- {n}_{2}^{2} / η} ⅆ {n}_{2} ) \\ ( \frac{1}{\sqrt{( π η )}} {\int }_{- \frac{d}{2} \sqrt{2}}^{∞} {ⅇ}^{- {n}_{3}^{2} / η} ⅆ {n}_{3} ) \\ = ( 1 - Q ( \frac{d}{\sqrt{( 2 η )}} ) ) ( 1 - 2 Q ( \frac{d}{\sqrt{( 2 η )}} ) ) ( 1 - Q ( \frac{d}{2 \sqrt{η}} ) )\end{matrix} \qquad ( N )$$

Assuming an equi-probable transmission of symbols, the symbol error probability of the system is given by
pₑ(s)=1−p(c/HP₂) (O)

The equation (H) can be expressed in terms of the bit energy E_{b} as shown below.

The Euclidean distance is related to the symbol energy (radius of the sphere) as

$$d = \frac{2 \sqrt{2}}{\sqrt{3}} \sqrt{{E}_{s}} \\ {d}^{2} = \frac{16}{3} {E}_{b} \qquad ( P )$$

Substituting this into equation (H), and replacing η=Nₒ

$$\begin{matrix}{p}_{e} ( s ) = 1 - [ ( 1 - Q ( \frac{2 \sqrt{2}}{\sqrt{3}} \sqrt{\frac{{E}_{b}}{{N}_{o}}} ) ) \\ ( 1 - 2 Q ( \frac{2 \sqrt{2}}{\sqrt{3}} \sqrt{\frac{{E}_{b}}{{N}_{o}}} ) ) ( 1 - Q ( \frac{2}{\sqrt{3}} \sqrt{\frac{{E}_{b}}{{N}_{o}}} ) ) ]\end{matrix} \qquad ( Q )$$

The above equation gives the BER performance in a closed form. This is plotted against that of QPSK in FIG. 17.

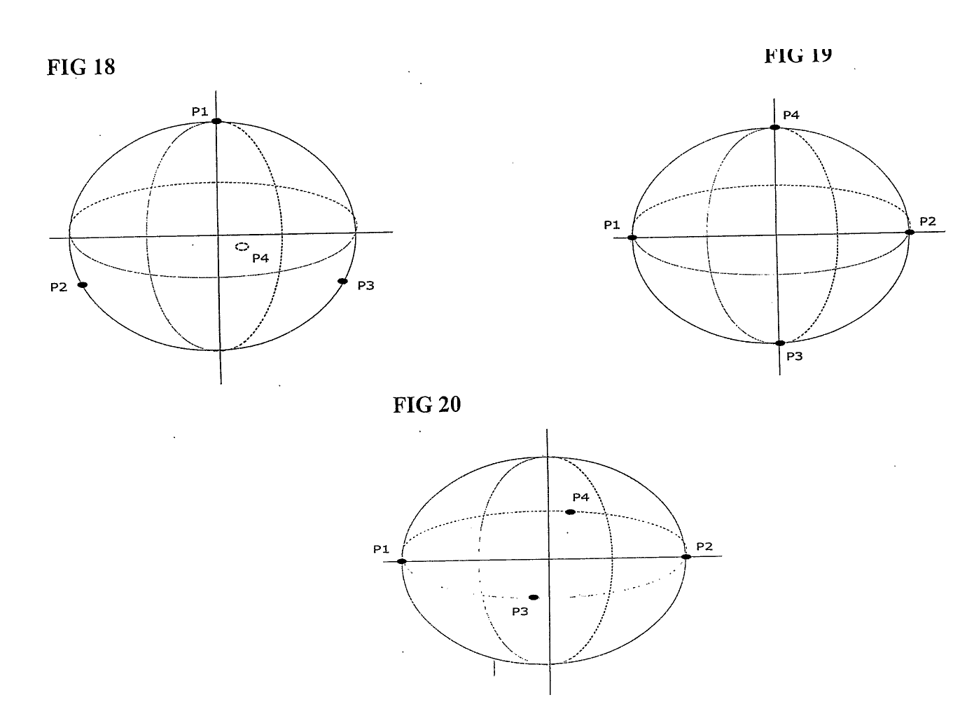

The four polarization constellation set shown in FIG. 18 also shows similar properties. Having the same Euclidean distance as the 16, this signal space also provides a similar BER performance.

TABLE 6
Essential data for the 4 point constellation in FIG. 18

| Points | 2ε | 2τ | 2γ | δ | S₁ | S₂ | S₃ | α₁ | α₂ | δ |
|---|---|---|---|---|---|---|---|---|---|---|
| P₁ | 90 | 90 | 90 | 90 | 0 | 0 | 1 | 0.707 | 0.707 | 90 |
| P₂ | −19.475 | 0 | 19.45 | −90 | 0.9428 | 0 | −0.3333 | 0.9855 | 0.1691 | −90 |
| P₃ | −19.475 | 120 | 118.12 | −22.21 | −0.4713 | 0.8165 | −0.3333 | 0.5141 | 0.8577 | −22.21 |
| P₄ | −19.475 | 240 | 118.12 | −157.8 | −0.4713 | −0.8165 | −0.3333 | 0.5141 | 0.8577 | −157.8 |

FIG. 19 and the below table 7 give another useful set of SOPs which are 2 linear and 2 circular.

TABLE 7
Essential data for the 4 point constellation in FIG. 19

| Points | 2ε | 2τ | 2γ | δ | S₁ | S₂ | S₃ | α₁ | α₂ | δ |
|---|---|---|---|---|---|---|---|---|---|---|
| P₁ | 0 | 0 | 0 | 0 | 1 | 0 | 0 | 1 | 0 | 0 |
| P₂ | 0 | 180 | 180 | 0 | −1 | 0 | 0 | 0 | 1 | 0 |
| P₃ | −90 | 90 | 90 | 90 | 0 | 0 | −1 | 0.707 | 0.707 | 90 |
| P₄ | 90 | 90 | 90 | −90 | 0 | 0 | 1 | 0.707 | 0.707 | −90 |

They are useful when used in 4 in 4 out MIMO systems with simple off the shelf antenna for transmission and reception. FIG. 20 and the corresponding below Table 8 represent another such advantageously simple arrangement employing 4 linear polarizations.

TABLE 8
Essential data for the 4 point constellation in FIG. 20

| Points | 2ε | 2τ | 2γ | δ | S₁ | S₂ | S₃ | α₁ | α₂ | δ |
|---|---|---|---|---|---|---|---|---|---|---|
| P₁ | 0 | 0 | 0 | 0 | 1 | 0 | 0 | 1 | 0 | 0 |
| P₂ | 0 | 180 | 180 | 0 | −1 | 0 | 0 | 0 | 1 | 0 |
| P₃ | 0 | 90 | 90 | 0 | 0 | 1 | 0 | 0.707 | 0.707 | 0 |
| P4 | 0 | 270 | 270 | 180 | 0 | −1 | 0 | 0.707 | 0.707 | 180 |

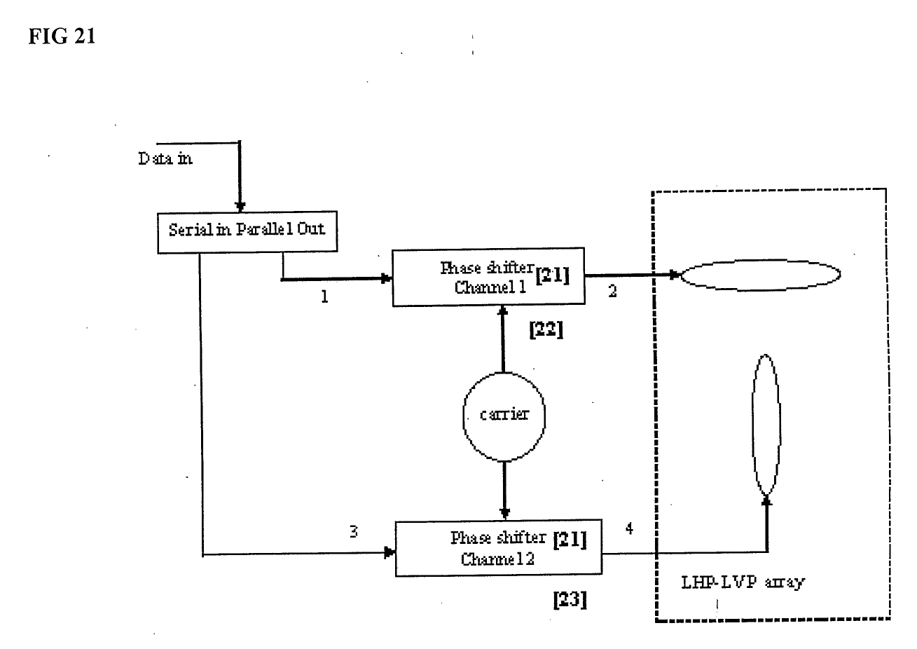

An advantageously simple quadrature polarization shift keying modulation for wireless communication is provided here. Block diagram of this system is given in FIG. 21.

The phase shifter [21] in the upper channel [22] provides the following phase shift.

| I bit at 1 | phaseshift = δ₁ | Output at 2 |
|---|---|---|
| 0 | 0° | cos(ω_{c}t) |
| 1 | 90° | cos(ω_{c}t + 90°) |

The phase shifter [21] in the lower channel [23] provides the following phase shift.

| Q bit at 3 | phaseshift = δ₂ | Output at 4 |
|---|---|---|
| 0 | −90° | cos(ω_{c}t − 90°) |
| 1 | 90° | cos(ω_{c}t + 90°) |

These outputs are fed to a LHP-LVP combination antenna. The SOPs generated can be seen in the FIG. 19. This structure is one of the simplest QPolSK which can be used for many applications.

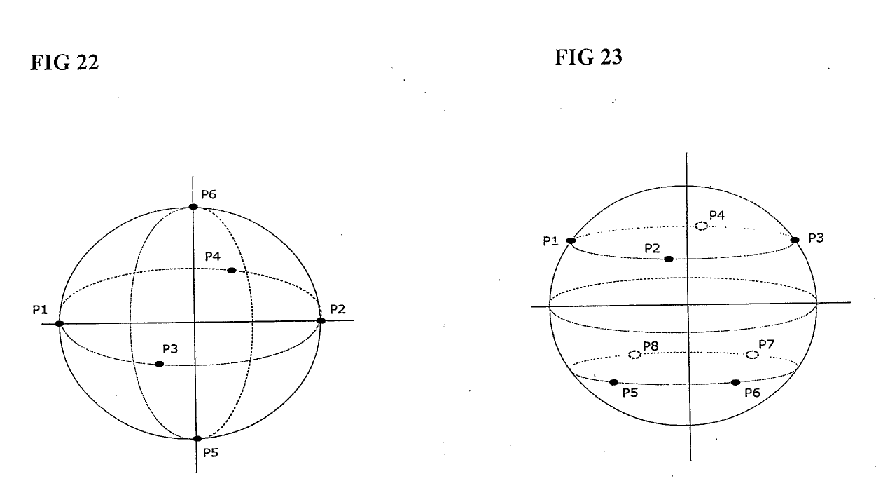

A novel constellation arrangement for 6 points is shown in FIG. 22. Its corresponding information is given below in Table 9. The Euclidean distance is 1.414 in this arrangement on a unit sphere.

TABLE 9
Essential data for the 6 point constellation in FIG. 22

| Points | 2ε | 2τ | 2γ | δ | S₁ | S₂ | S₃ | α₁ | α₂ | δ |
|---|---|---|---|---|---|---|---|---|---|---|
| P₁ | 0 | 0 | 0 | 0 | 1 | 0 | 0 | 1 | 0 | 0 |
| P₂ | 0 | 180 | 180 | 0 | −1 | 0 | 0 | 0 | 1 | 0 |
| P₃ | 0 | 90 | 90 | 0 | 0 | 1 | 0 | 0.707 | 0.707 | 0 |
| P4 | 0 | 270 | 270 | 180 | 0 | −1 | 0 | 0.707 | 0.707 | 180 |
| P5 | −90 | 90 | 90 | 90 | 0 | 0 | −1 | 0.707 | 0.707 | 90 |
| P6 | 90 | 90 | 90 | −90 | 0 | 0 | 1 | 0.707 | 0.707 | −90 |

A constellation diagram with 8 spherically symmetric points on the Poincarésphere is shown in FIG. 23. Points on the upper hemisphere are called HP1, HP2, HP3 and HP4. Points on the lower hemisphere are called LP1, LP2, LP3, and LP4. These points are arranged on a unit sphere (\sqrt{E}ₓ=1) with the maximum Euclidean distance of

$${d}_{min} = \frac{2}{\sqrt{3}} .$$

Other relevant information on this constellation is given in below in Table 10.

TABLE 10
Essential data for the 8 point constellation in FIG. 23

| Points | 2ε | 2τ | 2γ | δ | S₁ | S₂ | S₃ | α₁ | α₂ | δ |
|---|---|---|---|---|---|---|---|---|---|---|
| P₁ | 35.26 | 0 | 35.26 | 90 | 0.8166 | 0 | 0.5773 | 0.9530 | 0.3028 | 90 |
| P₂ | 35.26 | 90 | 90 | 35.26 | 0 | 0.8166 | 0.5773 | 0.7071 | 0.7071 | 35.26 |
| P₃ | 35.26 | 180 | 144.7 | 90 | −0.8166 | 0 | 0.5773 | 0.3028 | 0.9530 | 90 |
| P4 | 35.26 | 270 | 90 | 144.7 | 0 | −0.8166 | 0.5773 | 0.7071 | 0.7071 | 144.7 |
| P5 | −35.26 | 45 | 54.73 | −45 | 0.5773 | 0.5773 | −0.5773 | 0.8881 | 0.4597 | −45 |
| P6 | −35.26 | 135 | 125.27 | −45 | −0.5773 | 0.5773 | −0.5773 | 0.4597 | 0.8881 | −45 |
| P7 | −35.26 | 225 | 125.27 | −135 | −0.5773 | −0.5773 | −0.5773 | 0.4597 | 0.8881 | −135 |
| P8 | −35.26 | 315 | 54.73 | −135 | 0.5773 | −0.5773 | −0.5773 | 0.8881 | 0.4597 | −135 |

The signal space for the above constellation arrangement can be represented by the same three orthogonal basis functions discussed in section V, given by equation (K). For the points on the unit sphere, with \sqrt{E}ₛ=1 and

$${d}_{min} = \frac{2}{\sqrt{3}} ,$$

the set of coordinates of each point is given as below.

$$HP 1 \text{:} \{ {d}_{min} / \sqrt{2} , 0 , {d}_{min} / 2 \} \\ HP 2 \text{:} \{ 0 , {d}_{min} / \sqrt{2} , {d}_{min} / 2 \} \\ HP 3 \text{:} \{ - {d}_{min} / \sqrt{2} , 0 , {d}_{min} / 2 \} \\ HP 4 \text{:} \{ 0 , - {d}_{min} / \sqrt{2} , {d}_{min} / 2 \} \\ LP 1 \text{:} \{ {d}_{min} / 2 , {d}_{min} / 2 , - {d}_{min} / 2 \} \\ LP 2 \text{:} \{ - {d}_{min} / 2 , {d}_{min} / 2 , - {d}_{min} / 2 \} \\ LP 3 \text{:} \{ - {d}_{min} / 2 , - {d}_{min} / 2 , - {d}_{min} / 2 \} \\ LP 4 \text{:} \{ {d}_{min} / 2 , - {d}_{min} / 2 , - {d}_{min} / 2 \} \qquad ( R )$$

Let n₁, n_{2,} n₃ be the relevant noise components along the three axes with zero mean and variance σ²=η−/2. It will be convenient to calculate the probability of correct decision P_{c} and then determine the probability of symbol error as pₛ=1−p_{c}.

Assuming that the point HP3 is transmitted, the probability of a correct decision is given by

$$\begin{matrix}P ( C / {HP}_{3} ) = ( \frac{1}{\sqrt{( π η )}} {\int }_{- ∞}^{d / 2} {ⅇ}^{- {n}_{1}^{2} / η} ⅆ {n}_{1} ) ( \frac{1}{\sqrt{( π η )}} {\int }_{- d / 2}^{d / 2} {ⅇ}^{- {n}_{2}^{2} / η} ⅆ {n}_{2} ) \\ ( \frac{1}{\sqrt{( π η )}} {\int }_{- d / 2}^{∞} {ⅇ}^{- {n}_{3}^{2} / η} ⅆ {n}_{3} ) \\ = ( 1 - Q ( \frac{d}{\sqrt{( 2 η )}} ) ) ( 1 - 2 Q ( \frac{d}{\sqrt{( 2 η )}} ) ) ( 1 - Q ( \frac{d}{\sqrt{( 2 η )}} ) )\end{matrix} \qquad ( S )$$

Assuming an equi-probable transmission of symbols, the symbol error probability of the system is given by
pₑ(s)=1−p(c/HP₃)

The equation can be expressed in terms of the bit energy E_{b} as shown below.

The Euclidean distance is related to the symbol energy (radius of the sphere) as

$$d = \frac{2}{\sqrt{3}} \sqrt{{E}_{s}}$$

$${d}^{2} = \frac{4}{3} ( 3 {E}_{b} ) = 4 {E}_{b}$$

Substituting this into (S), and replacing η=Nₒ

$${p}_{e} ( s ) = 1 - [ ( 1 - Q ( \sqrt{2} \sqrt{\frac{{E}_{b}}{{N}_{o}}} ) ) ( 1 - 2 Q ( \sqrt{2} \sqrt{\frac{{E}_{b}}{{N}_{o}}} ) ) ( 1 - Q ( \sqrt{2} \sqrt{\frac{{E}_{b}}{{N}_{o}}} ) ) ] \qquad ( T )$$

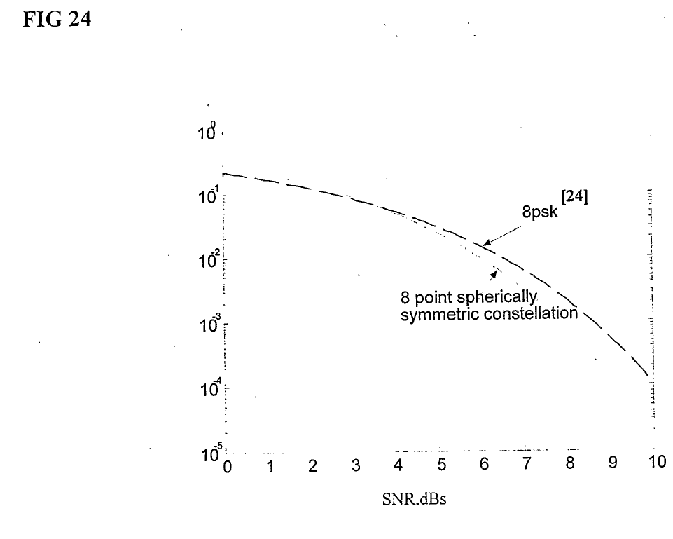

The above equation gives the symbol error performance in a closed form and it is compared to that of 8PSK[24] in the FIG. 24. It can be seen that, there is a considerable improvement in symbol error performance of the proposed system. The improvement in performance for an error rate of 10⁻⁴ is around 1 dB compared to an 8 PSK[24] system.

Using polarization as a multiplexing parameter results in co channel cross polarized frequency reuse systems. Prior art has shown that by using two orthogonal polarizations such as LHP [7], LVP [8] pair, +45degree pair or LHCP [5], RHCP [6] pair, two channels for data transmission can be obtained for the same frequency band, thus offering two times the data rate. This embodiment of the present invention extends the frequency reuse to 3 and 4 parallel channels. The optimum polarizations have been provided for both the cases and their performance evaluated.

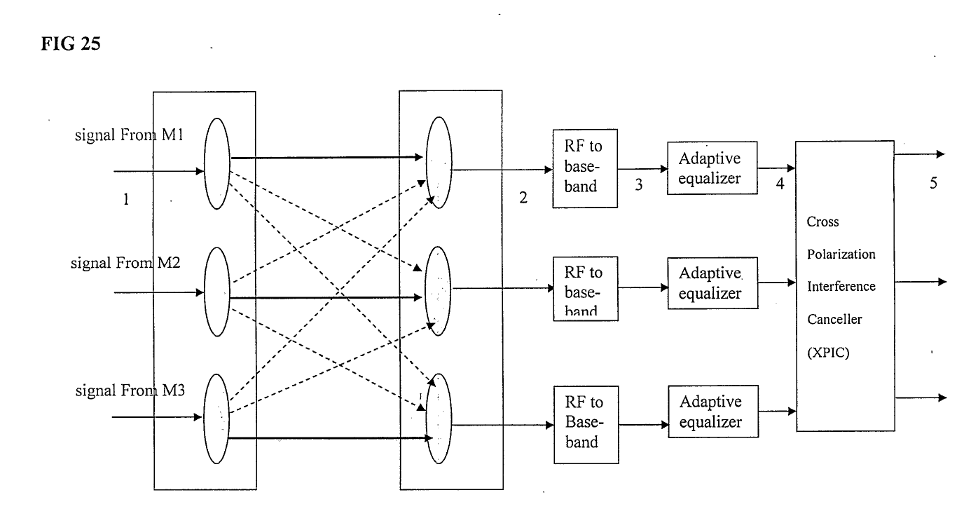

A tri-polarized co channel frequency reuse system employs 3 separate antennae to transmit and receive 3 different data streams to achieve a data rate which is 3 times that of a SISO system. Block diagram of such a system is shown in FIG. 25. These systems employ 3 different antennae of 3 different SOPs which offer maximum cross polarization isolation. The optimum SOPs of the antennas are shown in the constellation FIGS. 13 and 14. The receiver employs an adaptive equalizer which computes the channel state information apriori to the transmission of data and uses pilot symbol insertion to train the adaptive filter. Once the adaptation happens, the receiver is expected to fully know the channel. The same antenna structure can be used at the receiver to receive the signal.

Assume a channel which offers flat fading for the frequency band of interest. The channel input output for this system can be modeled as
r=\sqrt{E}ₓH_{i,j}x+n (U)
which can be written in matrix form as

$$[ \begin{matrix}r \\ {r}_{1} \\ {r}_{2}\end{matrix} ] = \sqrt{{E}_{s}} [ \begin{matrix}{h}_{0 , 0} {h}_{0 , 1} {h}_{0 , 2} \\ {h}_{1 , 0} {h}_{1 , 1} {h}_{1 , 2} \\ {h}_{2 , 0} {h}_{2 , 1} {h}_{2 , 2}\end{matrix} ] X [ \begin{matrix}{x}_{0} \\ {x}_{1} \\ {x}_{2}\end{matrix} ] + n \qquad ( V )$$

where n is the WSS noise with IID components.

The matrix H_{i,j} is conventionally called the channel matrix of a MIMO system. When used in frequency re-use using multiplexing in the polarization domain, the matrix can be called as polarization matrix.

Here we assume that the transmitter and receiver use the same polarization. The actual values of the coefficients depend on the propagation conditions. These values are expected to be complex gaussian random variables with a mean value shown in the matrix above. For simplicity of analysis, we can assume that

$$ɛ \{ {\vert {h}_{0 , 0} \vert}^{2} \} = ɛ \{ {\vert {h}_{1 , 1} \vert}^{2} \} = ɛ \{ {\vert {h}_{2 , 2} \vert}^{2} \} = 1 and \qquad ( W )$$

The ensemble average of the cross coupled components as their mean value m_{i,j}. Cross polarization discrimination of the channel and the antennae determine these coefficients. By using an antenna of high XPD, it is possible to achieve a small value for the average component m_{i,j}. The total XPD of each cross coupled branch can be represented by
h_{i,j(total)}=h_{i,j(static)}+m_{i,j,i≠j} (X1) (x1)
and
H_{i,j}=H_{i,j(static)}+└m_{i,j}┘ (X2)

The H_{i,j(static)}, which describes the inherent cross coupling between the polarizations employed can be computed from the Polarizations employed for the frequency re-use. These matrices are dependent on the chosen SOPs and their position on the sphere. By using standard methods of computing the cross polar isolation, these values can be easily found.

At the receiver, the channel estimation can be used with any of the known methods of the prior art cross polarization interference cancellation methods to remove the cross polarized component to regenerate the three different data streams. The channel estimation is performed by a suitable adaptive filter algorithm such as the LMS or RLS algorithm. Analysis and design procedures of the adaptive filter and cross polarization interference canceller are abundant in prior art. The major difference here is in the H matrix where, in the dual polarized systems described in prior art, the H matrix is described by
H_{i,j}=H_{i,j(static)}+└m_{i,j}┘ (Y1)

With H_{i,j(static)} being an identity matrix giving rise to

$${H}_{i , j} = [ \begin{matrix}1 , {m}_{0 , 1} , {m}_{0 , 2} \\ {m}_{1 , 0} 1 , {m}_{1 , 2} \\ {m}_{2 , 0} {m}_{2 , 1} 1\end{matrix} ] \qquad ( Y2 )$$

When it is assumed that m_{i,j}=m_{j,1}=α and all cross polarized terms to be equal, we get a matrix channel as

$${H}_{i , j} = [ \begin{matrix}1 , α , α \\ α , 1 , α \\ α , α , 1\end{matrix} ] \qquad ( Y3 )$$

In the system presented here, the cross polarization components are bigger due to the non-identity H_{i,j(static)} matrix. However, as the individual values of these cross polar elements (the non-diagonal elements of H_{i,j(static))} are known apriori, the contribution of these components can be subtracted at the receiver to generate a system which is equal in performance to the dual polarized frequency re-use systems of the prior art.

A quad-polarized co channel frequency reuse system employs 4 separate antennae to transmit and receive 4 different data streams to achieve a data rate which is 4 times that of a SISO system.

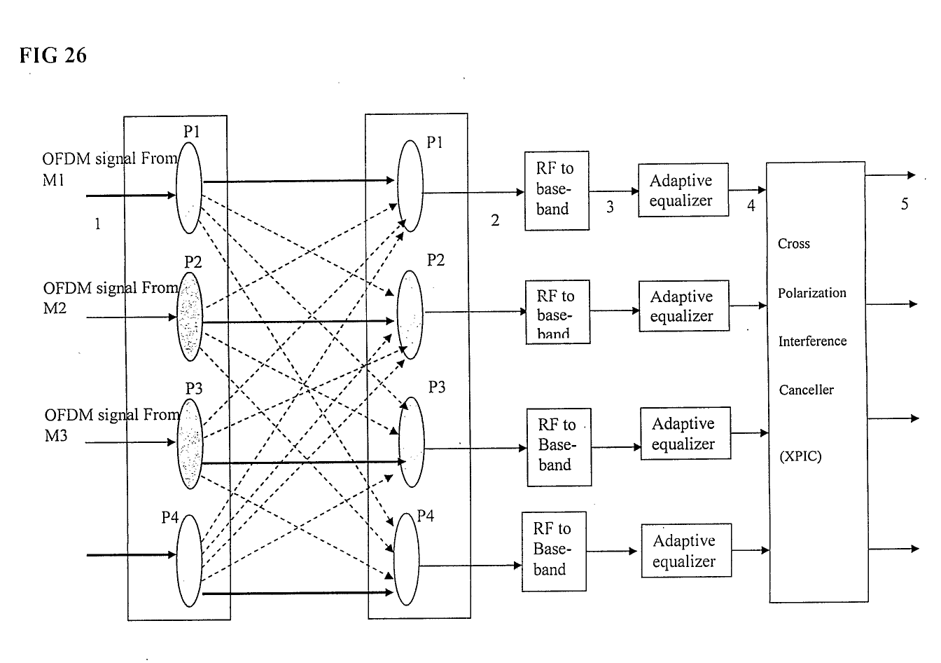

Block diagram of such a system is shown in FIG. 26. These systems employ 4 different antennae of 4 different SOPs which offer maximum cross polarization isolation. They are shown in the constellation FIGS. 16 and 17 and other 4 point constellations of this invention. The receiver employs an adaptive equalizer which computes the channel state information apriori to the transmission of data and uses pilot symbol insertion to train the adaptive filter. Once the adaptation happens, the receiver is expected to fully know the channel.

Assume a channel which offers flat fading for the frequency band of interest. The channel input output for this system can be modeled as
r=\sqrt{E}ₛH_{i,j}x+n

Which can be written in matrix form as

$$[ \begin{matrix}r \\ {r}_{1} \\ {r}_{2} \\ {r}_{4}\end{matrix} ] = \sqrt{{E}_{s}} [ \begin{matrix}{h}_{0 , 0} & {h}_{0 , 1} & {h}_{0 , 2} & {h}_{0 , 3} \\ {h}_{1 , 0} & {h}_{1 , 1} & {h}_{1 , 2} & {h}_{1 , 3} \\ {h}_{2 , 0} & {h}_{2 , 1} & {h}_{2 , 2} & {h}_{2 , 3} \\ {h}_{3 , 0} & {h}_{3 , 1} & {h}_{3 , 2} & {h}_{3 , 3}\end{matrix} ] \times [ \begin{matrix}{x}_{0} \\ {x}_{1} \\ {x}_{2} \\ {x}_{3}\end{matrix} ] + n \qquad ( Z 1 )$$

Where n is the WSS noise with IID components.

The matrix H_{i,j} is conventionally called the channel matrix of a MIMO system. When used in frequency re-use using multiplexing in the polarization domain, the matrix can be called as polarization matrix.

Here we assume that the transmitter and receiver use the same polarization. The actual values of the coefficients depend on the propagation conditions and the polarizations chosen. These values are expected to be complex gaussian random variables with a mean given by m_{i,j}. For simplicity of analysis, we can assume that

$$ɛ \{ {\vert {h}_{0 , 0} \vert}^{2} \} = ɛ \{ {\vert {h}_{1 , 1} \vert}^{2} \} = ɛ \{ {\vert {h}_{2 , 2} \vert}^{2} \} = 1 and$$

the ensemble average of the cross coupled components as their mean value m_{i,j}. Cross polarization discrimination of the channel and the antennae determine these coefficients. By using an antenna of high XPD, it is possible to achieve a small value for the average component m_{i,j}. The total XPD of each cross coupled branch can be represented by
h_{i,j(total)}=h_{i,j(static)}+m_{i,j,i≠j}
and
H_{i,j}=H_{i,j(static)}+└m_{i,j}┘ (Z2)

The H_{i,j(static)} can be computed from the Polarizations employed for the frequency re-use. At the receiver, the channel estimation can be used with any of the known methods of the prior art cross polarization interference cancellation methods to remove the cross polarized component to regenerate the three different data streams.

This object of the invention can result in more than 1 or 2 antenna at the receiver and more than 3 or 4 antennae at the transmitter thus offering a diversity gain up to 64. When used with proper STTC design, the system will offer unprecedented coding gain as well. In prior art, MIMO antenna installation and the number of antenna elements have been severely restricted by the inter element spacing of nearly 10 lambda, where lambda is the wavelength of the signal. The large spacing was required because base stations were usually mounted on elevated positions where the presence of local scatterers to offer uncorrelated scattering cannot be guaranteed always. This has limited the number of antenna to be 2, 3 or 4. The shorter length or separation at the mobile terminal is due to the presence of local scatterers resulting in uncorrelated fading always. However, for handsets, fitting of even two antennae is not advisable due to the aesthetical requirement of embedded antennae.

In this embodiment of the present invention, the antennae of different states of polarization are suggested to be used. When used in MIMO systems, these antennae with optimally selected SOPs offering a high degree of cross polarization isolation provide channels with uncorrelated fading even when the inter element spacing is less than 1 lambda for outdoor and 0.1 lambda for indoor. Hence, this present embodiment facilitates a closer placement of the antennae when used for diversity/multiplexing and/or state time trellis or block coding. This is an advantageous benefit as the space requirement for antennae installation can be minimal, the problems associated with varying angle of arrival can be avoided and a suitable radome can be designed for the prolonged life of the antennae.

Fading experienced by different polarizations have known to be uncorrelated in both urban, semi urban or rural situations and has maintained this property for both indoor and outdoor wireless channels.

This embodiment of the present invention facilitates toe following
1. To reduce the inter element antenna spacing to less than 1 lambda at the base station
2. To employ upto 8 antenna of different SOPs at the transmitter. The optimum SOPs for 2, 3, 4, 6, and 8 antenna at transmit or receive or both terminals are given in the corresponding constellation diagrams.
3. To employ 2, 3, 4, 6 or 8 antennae of different SOP at the receiver.
4. To offer a transmit diversity of up to 64 (8 Tx. and 8 Rx.)
5. To offer up to 8 multiplexing channels with or without the use of adaptive modulation and space time coding.

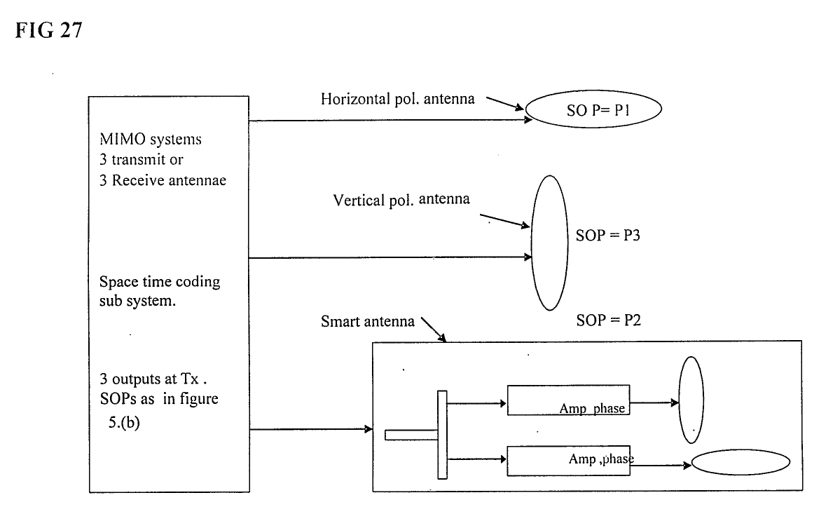

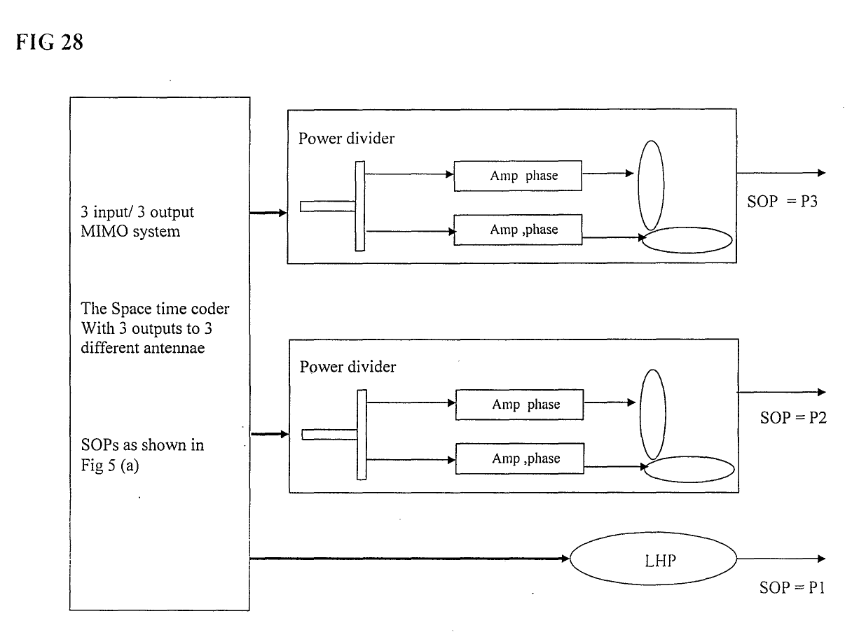

As an example, the transmitting side antenna configuration of 3 in 3 out MIMO system employing the antennas of SOPs corresponding to FIG. 13 is shown in FIG. 25. A similar antenna configuration at the receiver can give rise to 3 in 3 out MIMO system where the antennas can be closely spaced compared to the present structures where there is a minimum distance between the antennas. FIG. 26 shows the transmitting side antenna configuration when the antennas used are having the SOPs shown in FIG. 13. Similar arrangements are given in FIGS. 27 and 28.

By employing such antennas of optimally selected SOPs, the MIMO configuration of higher order can be employed. This is an advantageous situation compared to the previous art.

1. A method of wireless communication based on multiplexing in a system of multiple-input-multiple-output antennas, comprising:
selecting a plurality of states of polarization;
providing antenna arrays capable of generating signals of the selected states of polarization;
transmitting signals simultaneously by multiplexing in a plurality of channels,
wherein each channel of the plurality of channels is assigned to one of the plurality of states of polarization.

2. The method according to claim 1, wherein the step of selecting a plurality of states of polarization comprises:
maximizing the Euclidian distances between the plurality of states of polarization on the Pointcaré sphere.

3. The method according to claim 1, wherein the step of providing antenna arrays capable of generating signals of the selected states of polarization comprises:
providing a set of antennas of orthogonal polarization.

4. The method according to claim 3, wherein the set of antennas of orthogonal polarization are connected to a signal processor.

5. The method according to claim 3, wherein the set of antennas of orthogonal polarization is connected to a power divider, discrete phase-shifter and attenator to change the polarization of signal for narrow-band modulating.

6. The method according to claim 1, wherein the step of transmitting signals comprises generating of RF-signals with required states of polarization.

7. The method according to claim 1, wherein the step of transmitting signals comprises polarization modulating.

8. The method according to claim 1, wherein the number of the plurality of channels is three or more.

9. The method according to claim 2, wherein the plurality of states of polarization on said Pointcaré sphere comprises P1, P2 and P3 with the electric vectors \vec{E}ₓ and \vec{E}_{y} given by:
P1:
\vec{E}ₓ(t)=1{\vec{x} cos(107 t)}
\vec{E}_{y}(t)=0
P2:
\vec{E}ₓ(t)=−0.5{\vec{x} cos(ωt)}
\vec{E}_{y}(t)=−0.866{\vec{x} cos(ωt)}
and
P3:
\vec{E}ₓ(t)=−0.5{\vec{x} cos(ωt)}
\vec{E}_{y}(t)=−0.866{\vec{x} cos(ωt+90°)}.

10. The method according to claim 2, wherein the plurality of states of polarization on said Pointcaré sphere comprises P1 to P4 with the electric vectors \vec{E}ₓ and \vec{E}_{y} given by:
P1:
\vec{E}ₓ(t)=0.953(\vec{x} cos ωt)
\vec{E}_{y}(t)=0.303{\vec{x} cos(ωt+90°)}
P2:
\vec{E}ₓ(t)=0.707(\vec{x} cos(ωt)
\vec{E}_{y}(t)=0.707{\vec{x} cos(ωt−35.27°)}
P3:
\vec{E}ₓ(t)=0.303(\vec{x} cos ωt)
\vec{E}_{y}(t)=0.953{\vec{x} cos(ωt+90°)}
and
P4:
\vec{E}ₓ(t)=0.707(\vec{x} cos ωt)
\vec{E}_{y}(t)=0.707{\vec{x} cos(ωt−144.7°)}.

11. The method according to claim 2, wherein the plurality of states on said Pointcaré sphere comprises P1 to P4 with the electric vectors \vec{E}ₓ and \vec{E}_{y} given by:
P1:
\vec{E}ₓ(t)=0.707(\vec{x} cos ωt)
\vec{E}_{y}(t)=0.707{\vec{x} cos(ωt+90°)}
P2:
\vec{E}ₓ(t)=0.9855(\vec{x} cos ωt)
\vec{E}_{y}(t)=0.1691{\vec{x} cos(ωt−90°)}
P3:
\vec{E}ₓ(t)=0.5141(\vec{x} cos ωt)
\vec{E}_{y}(t)=0.8577{\vec{x} cos(ωt−22.21°)}
and
P4:
\vec{E}ₓ(t)=0.5141(\vec{x} cos ωt)
\vec{E}_{y}(t)=0.8577{\vec{x} cos(ωt−157.8°)}.

12. The method according to claim 2, wherein the plurality of states on said Pointcaré sphere comprises P1 to P4 with the electric vectors \vec{E}ₓ and \vec{E}_{y} given by:
P1:
\vec{E}ₓ(t)=1.0(\vec{x} cos ωt)
\vec{E}_{y}(t)=0){\vec{x} cos(ωt+0°)}
P2:
\vec{E}ₓ(t)=0)(\vec{x} cos ωt)
\vec{E}_{y}(t)=1.0{\vec{x} cos(ωt+0°)}
P3:
\vec{E}ₓ(t)=0.707(\vec{x} cos ωt)
\vec{E}_{y}(t)=0.707{\vec{x} cos(ωt+90°)}
and
P4:
\vec{E}ₓ(t)=0.707(\vec{x} cos ωt)
\vec{E}_{y}(t)=0.707{\vec{x} cos(ωt−90°)}.

13. The method according to claim 2, wherein the plurality of states on said Pointcaré sphere comprises P1 to P4 with the electric vectors \vec{E}ₓ and \vec{E}_{y} given by:
P1:
\vec{E}ₓ(t) =1.0(\vec{x} cos ωt)
\vec{E}_{y}(t)=(0){\vec{x} cos(ωt+0°)}
P2:
\vec{E}ₓ(t) =0)(\vec{x} cos ωt)
\vec{E}_{y}(t)=1.0{\vec{x} cos(ωt+0°)}
P3:
\vec{E}ₓ(t) =0.707(\vec{x} cos ωt)
\vec{E}_{y}(t)=0.707{\vec{x} cos(ωt+0°)}
and
P4:
\vec{E}ₓ(t) =0.707(\vec{x} cos ωt)
\vec{E}_{y}(t)=0.707{\vec{x} cos(ωt+180°)}.

14. The method according to claim 2, wherein the plurality of states comprises P1 to P6 with the electric vectors \vec{E}ₓ and \vec{E}_{y} given by:
P1:
\vec{E}ₓ(t) =1.0(\vec{x} cos ωt)
\vec{E}_{y}(t)=(0){\vec{x} cos(ωt+0°)}
P2:
\vec{E}ₓ(t) =0)(\vec{x} cos ωt)
\vec{E}_{y}(t)=1.0{\vec{x} cos(ωt+0°)}
P3:
\vec{E}ₓ(t) =0.707(\vec{x} cos ωt)
\vec{E}_{y}(t)=0.707{\vec{x} cos(ωt+0°)}
P4:
\vec{E}ₓ(t) =0.707(\vec{x} cos ωt)
\vec{E}_{y}(t)=0.707{\vec{x} cos(ωt+180°)}
P5:
\vec{E}ₓ(t) =0.707(\vec{x} cos ωt)
\vec{E}_{y}(t)=0.707{\vec{x} cos(ωt+90°)}
and
P6:
\vec{E}ₓ(t) =0.707(\vec{x} cos ωt)
\vec{E}_{y}(t)=0.707{\vec{x} cos(ωt−90°)}.

15. The method according to claim 2, wherein the plurality of states on said Pointcaré sphere comprises P1 to P8 with the electric vectors \vec{E}ₓ and \vec{E}_{y} given by:
P1:
\vec{E}ₓ(t) =0.953(\vec{x} cos ωt)
\vec{E}_{y}(t)=(0.302{\vec{x} cos(ωt+90°)}
P2:
\vec{E}ₓ(t) =0.707(\vec{x} cos ωt)
\vec{E}_{y}(t)=0.707{\vec{x} cos(ωt+35.26°)}
P3:
\vec{E}ₓ(t) =0.3028(\vec{x} cos ωt)
\vec{E}_{y}(t)=0.9530{\vec{x} cos(ωt+90°)}
P4:
\vec{E}ₓ(t) =0.707(\vec{x} cos ωt)
\vec{E}_{y}(t)=0.707{\vec{x} cos(ωt+144.7°)}
P5:
\vec{E}ₓ(t) =0.888(\vec{x} cos ωt)
\vec{E}_{y}(t)=0.4597{\vec{x} cos(ωt−45°)}
P6:
\vec{E}ₓ(t) =0.4597(\vec{x} cos ωt)
\vec{E}_{y}(t)=0.8881{\vec{x} cos(ωt−45°)}
P7:
\vec{E}ₓ(t) =0.4597(\vec{x} cos ωt)
\vec{E}_{y}(t)=0.8881{\vec{x} cos(ωt−135°)}
and
P8:
\vec{E}ₓ(t) =0.8881(\vec{x} cos ωt)
\vec{E}_{y}(t)=0.4597{\vec{x} cos(ωt−135°)}.

16. Device for transmitting and/or receiving adapted for wireless communication according to the method of claim 1.
